(19) United States
(12) Patent Application Publication
(10) Pub. No.: US 2005/0166747 A1
(43) Pub. Date: Aug. 4, 2005

(54) Pneumatic apparatus for actuating a second valve device (such as a high or low-pressure valve system) useful in applications such as opening the valve of an air-powered projectile-launching machine

(76) Inventors: Ernest John Chenery, South Whitley, IN (US); Steven Russell Deam, Churubusco, IN (US)

Correspondence Address: Steven R. Deam, 3908 Fourier Dr., Fort Wayne, IN, 46818, US

(21) Appl. No.: 10/771,452

(22) Filed: Feb. 4, 2004

(51) Int. Cl. F15B 21/00

(52) U.S. Cl. 91/5

(57) ABSTRACT

A pneumatic apparatus for actuating a secondary device (such as a high-pressure valve) useful in applications, such as opening the valve of an air-powered projectile-launching device, including, but not limited to, a housing with one gas reservoir situated in a manner that will perform work when charged with gas pressure, a spring to bias the ram position in one direction against the work to be preformed, one air input port in the air reservoir, a quick evacuation valve (QEV) in communication with the port in the reservoir to allow air to flow into the air reservoir and then out again through the same path without resistance, and a means by which to return the ram to the start position using external air pressure exhausted from the secondary device (such as a pressure valve).

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of paintball and more specifically to a pneumatic apparatus for actuating a secondary device (such as a high-pressure valve), useful in applications such as opening the valve of an air-powered projectile-launching device.

The sport of paintball has enjoyed immense growth in the number of players in the past few years, and that growth has spurred the technology of paintball devices to advance quickly. Variations of paintball based games often put players in the position of trying to expel more paint filled frangible projectiles per second than the equipment used was capable of firing. The technological answer to the problem of slow equipment was to introduce electronically controlled systems that increase the number of cycles the equipment was capable of achieving per second. The result of introducing electronic control systems is that electronic systems deliver far more cycles than their mechanical counterparts are capable of completing per second.

As players use paint ever more rapidly in the paintball games that they play, it becomes more imperative that mechanical components are introduced capable of reaching higher cycle rates, thus making use of the faster cycle rates of the electronic control systems and allowing players to fire more rounds per second.

The more successful designs achieve higher rates of fire by utilizing a pneumatically driven ram that performs the same function that a hammer traditionally performs in paintball gun; that is to say that the ram opens the main valve that allows a volume of pressurized gas to push a paint filled frangible projectile out of the barrel end of a paintball gun. However as the player's desired speeds increase, the technology of these rams has not progressed accordingly.

This invention was produced in order to provide a ram for a paintball gun that would allow the entire system to cycle at rates that are unachievable with current designs. Since the ram cycle rate directly affects the cycle rate of every other system of a paintball gun, by increasing the number of times per second the ram can cycle, we also increase the number of times per second that the whole mechanism can cycle.

The ideal application of this device is in a paintball gun that provides a bolt that operates in communication with the ram, such that, as the ram cycles, the bolt cycles with it. This style of operation is traditionally called “open bolt” due to the fact that as the ram must move forward to open the valve, so must the bolt that loads the next projectile. This means the bolt must close the path that allows the projectiles into the breach before the ram opens the valve, therefore it must rest in a position to allow the next projectile into the breach; or in other words it must rest in the position that leaves the bolt open.

The design covered in this application can be operated by a mechanical control device or by employing a more sophisticated electronic control circuit that is activated by the. This flexibility in control makes it ideal for most air-powered gun designs, as well as many other pneumatic applications where it is ideal to employ a ram to open a valve.

This new invention also employs a unique feature for aiding the return of the ram to the start position by using a combination of exhausted pressurized gas released from the valve and a spring positioned to bias the ram in the start position. The return mechanism combination, in cooperation with a quick evacuation valve (QEV) allows the ram to cycle more quickly than the player is capable of triggering the control mechanism, allowing players to achieve rates of fire as fast as the trigger can be tripped.

When employed in a system where the control mechanism allows the user to select different firing options, like a fully automatic mode, the speed achieved by the ram will increase the overall cycle rate of the entire system. As methods for feeding bulk amounts of projectiles into the system improves, the rate of the ram can be increased by the governing system to compensate easily. The only restriction remaining on the system is the volume and pressure limit of the supplying air lines or hoses, which can be changed as needed to supply this ram.

One distinct shortcoming of prior designs for similar devices is that they were designed to charge their reservoirs quickly, but forced air to vent by means of the same hose or airline used to charge the reservoir, forcing the air to travel backwards through the system and slowing the return cycle down immensely. Previous attempts to overcome that deficiency included the addition of a second reservoir positioned opposite the piston to force the ram against the first reservoir and into the starting position quickly, but that solution does not address the problem of venting the pressurized reservoir quickly.

By adding a quick evacuation valve (QEV) in the airline, this new invention allows the pressurized gas in the charged reservoir to escape through a different path than the airline used to charge the reservoir in the first place. By the further addition of a Single Directional air seal, or U-Cup seal which creates an air seal only when traveling in one direction, on the piston, this invention allows for very high-speed cycle rates.

The invention is also biased in the back position by means of an internal compression spring that pushes the piston against the reservoir in a manner that, when the reservoir is not pressurized, pushes the piston all the way to the back position. By using this kind of spring bias, the ram will not accidentally cycle when the reservoirs are not charged and prevents the accidental loading of a round as well as the accidental opening of the valve.

Previous devices have utilized an internal reservoir to cycle the piston back to the start position, however they are also limited by the timing cycles when the ram is resetting to the open position. This invention includes a valve designed to automatically push the hammer on the ram piston back by using exhausted pressurized gas, which in turn resets the piston to the start position. In combination with the spring that already biases the piston to the back position, this spring assisted exhaust return setup decreases the cycle time of the ram, and increases the number of times per second that the mechanism can cycle.

### BRIEF SUMMARY OF THE INVENTION

The primary object of the invention is to provide a more reliable, more serviceable, and faster cycling air powered (pneumatic) ram for use in paintball guns and similar valve controlled pneumatic equipment.

Another object of the invention is to return the ram to the start position in as quick a manner as possible.

A further object of the invention is to supply a ram that operates on one or more pressurized gas inputs.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a pneumatic apparatus for actuating a second device (such as a high or low-pressure valve) useful in applications, such as opening the valve of an air-powered projectile-launching device or other valve-dependant pneumatic devices, comprising: a housing with one gas reservoir (15) situated in a manner that will perform work when charged with gas pressure (20), a spring (12) to bias the ram position in one direction, one air input port in the air reservoir, a QEV style valve (14) to allow air to flow into the air reservoir (19) and then out again through the same path (27) without resistance, and a means by which to return the ram to the start position using external air pressure (21).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of the invention showing the rest state.

FIG. 2 is a cross sectional view of the invention showing charged state.

FIG. 3 is a cross sectional view of the invention showing the return to the rest state.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

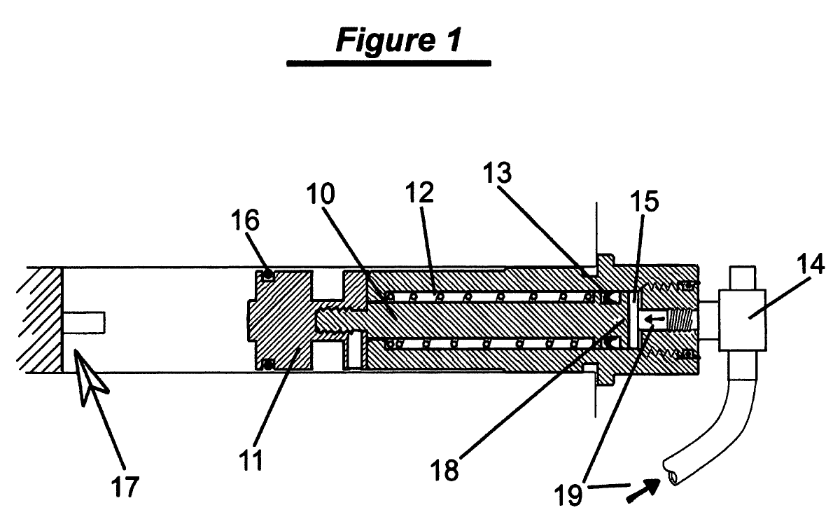

To accomplish the primary function of the invention, FIG. 1 shows the components necessary in the rest position. As in well-known devices of similar construction, this device must include a housing that provides a primary air reservoir (15) with limited volume, an armature (10) in communication with the reservoir through a single-directional seal (13) to allow the armature to be pushed forward when the reservoir is charged with gas pressure, and a mass in communication with the armature (11). One area where this invention differs from and improves upon previous well-known devices is with the addition of a quick evacuation valve (14), or QEV, to allow the rapid decompression of the reservoir (15) during the return to the rest, or start, position. This invention also takes advantage of a U-Cup seal (13) on the armature to crate a one-way seal. In other words, the U-Cup seal will not seal if the gas pressure outside the reservoir is greater the gas pressure inside the reservoir. Other features notable in FIG. 1 include a seal on the hammer (16), a retaining spring to hold the invention in the rest position (12), and a valve designed to exhaust a small amount of gas pressure that pushes against the seal on the hammer to return it to the start position (17).

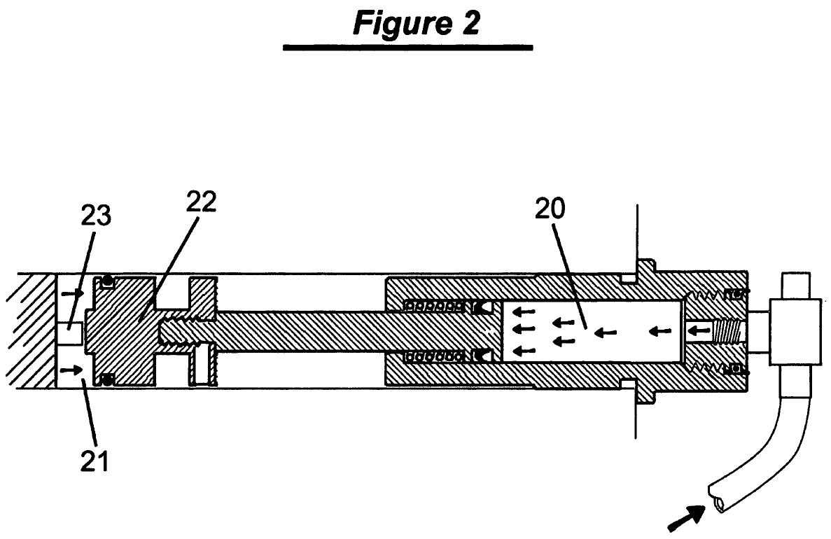

FIG. 2 illustrates the working position of the invention during the time that the reservoir is charged with compressed gas (20). In this position, the Armature extends, pushing the hammer (22) into the valve (23), which in turn releases some of its retained gas pressure back at the hammer (21). The hammer seal (16) allows the gas released from the valve (21) to build up rather than blowing around the hammer. This built-up gas pressure pushes the hammer back to the rest position in a process referred to in the area of paintball as “blow-back”. The spring (12) also assists the return of the apparatus to the rest position; a feature given the name “Spring Assisted Pneumatic Blowback Return.”

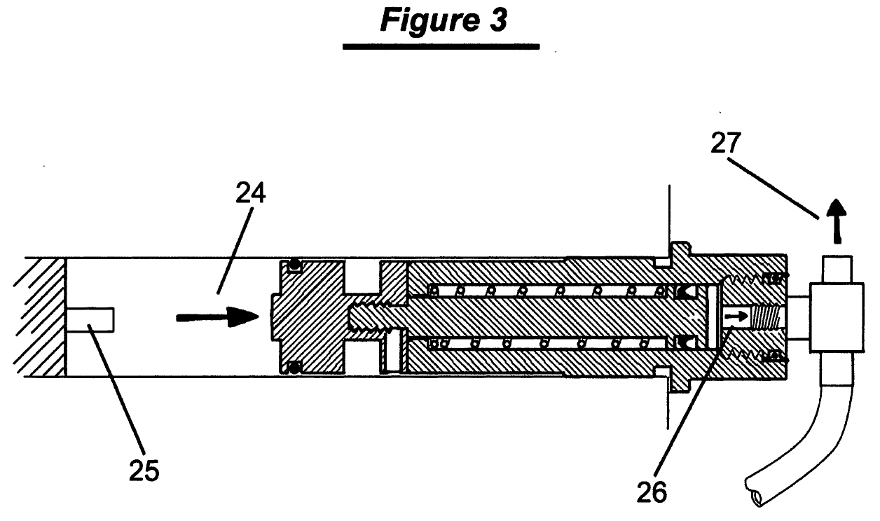

FIG. 3 is included to illustrate the path of gas exiting as the mechanism returns to the rest position. The gas released from the valve (24) reaches full expansion and is vented off. The reservoir returns to its rest position as in FIG. 1 (18), pushing the remaining pressurized gas (26) into the QEV, which vents the gas out a second port (27) rather than back into the hose like previous designs that create backpressure. The valve returns to its closed position (25) as soon as the weight of the hammer is pushed away, and seals itself shut again.

The application of this device in the field of invention, which is paintball, is intended to replace existing designs for rams in paintball guns. The rams in existing paintball gun designs perform the same work that a spring driven hammer would otherwise perform, that is to say that they open a valve that allows air to circulate through the gun's system to blow a paint filled frangible projectile out a barrel at a target. This improved device allows the system to cycle faster, allowing players to launch more projectiles at their targets at a faster pace. This invention also allows for simplified designs that include fewer parts, making the system easier to maintain. These are features desired of the paintball equipment used by most players. This design is intended to be useful in most of those systems.

The fast-cycling feature of this invention can also make it useful in many other non-paintball related pneumatically driven devices.

It should be noted that in this system, the ability of the valve to create blowback pressure is not intended as its only function. A valve that splits airflow to perform a different primary function and crate blowback pressure can be used in this system, as well as a valve that performs more that these two functions, as long as it also creates blowback pressure. It should further be noted that the invention is not intended to be limited to only the design shown in the illustrations, but rather the principal of the design to perform the desired functions including (but not limited to) the features shown.

It is not he intention of the inventors to patent the QEV, but rather its use in this device.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A pneumatic apparatus for actuating a secondary device (such as a high-pressure valve) useful in applications, such as opening the valve of an air-powered projectile-launching device, comprising:
A housing with one or more gas reservoirs situated in a manner that will perform work when charged with gas pressure;
A spring to bias the ram position in one direction;
One or more air inputs port in the air reservoir;
A quick evacuation valve (QEV) style valve to direct air to flow into the air reservoir and then out again through the same path without pressure resistance; and
A means by which to return the ram to the start position using external air pressure.

2. A pneumatically driven ram device and application means, useful in equipment such as air-powered guns, that performs the work of opening a normally closed valve and returning the device to the beginning of its cycle relieving pressure from the valve, allowing it to resume its normally shut position, comprising:
A valve designed to exhaust a small portion of gas flow back at the ram forcing the hammer of the ram back to its start or cocked position;
A hammer, designed to open the valve with momentum when the ram is charged with compressed gas by moving forward rapidly, that includes a seal to allow it to be repelled by the exhausted gas from the valve;
A gas-containing reservoir positioned rearward of said ram with one movable membrane arranged in such a manner that when the ram is in the normal cocked or start position the reservoir has no gas pressure inside it and the volume of said reservoir is relatively small, and when the ram is charged by allowing high pressure gas into said reservoir the reservoir expands to accommodate said gas pushing a ram armature that is connected to the hammer at the other end forward;
A U-shaped seal applied in a manner around the movable membrane of said reservoir as to provide a seal when the membrane moves forward, but relieves the seal when moving backwards to the start position;
A quickly evacuating valve assembly arranged in communication with said reservoir in such a manner as to create a sealed path for the high pressure gas flow into the reservoir, but allow the gas in the reservoir to escape rapidly through the same valve but out a different vent once the pressure in the air line is released;
